(19) United States
(12) Patent Application Publication
(10) Pub. No.: US 2025/0378599 A1
(43) Pub. Date: Dec. 11, 2025

(54) MACHINE-LEARNING BASED SKIN DETECTION AND MODIFICATION FOR IMAGES

(71) Applicant: Apple Inc., Cupertino, CA (US)

(72) Inventors: Abhishek SINGH, Los Altos, CA (US); Aditya Rajiv DESHPANDE, Champaign, IL (US); Vinay SHARMA, Palo Alto, CA (US)

(21) Appl. No.: 19/045,523

(22) Filed: Feb. 4, 2025

Related U.S. Application Data
(60) Provisional application No. 63/657,727, filed on Jun. 7, 2024.

(51) Int. Cl. G06T 11/00; G06T 7/11; G06T 7/90

(52) U.S. Cl. CPC G06T 11/001; G06T 7/11; G06T 7/90; G06T 2207/20081; G06T 2207/30196

(57) ABSTRACT

Systems and methods provide generating multimedia element. A machine learning model is used to generate a multimedia element depicting an entity and a set of attributes of the multimedia element. A particular attribute is determined from among the set of attributes and in response, the multimedia element is processed to generate one or more alternate multimedia elements where each multimedia element has a different version of the particular attribute. The one or more alternate multimedia elements are presented to the user and in response the user selects a multimedia element for use.

### CROSS REFERENCE TO RELATED APPLICATIONS

This application claims the benefit of U.S. Provisional Application No. 63/657,727, entitled “Machine-Learning Based Skin Detection for Images,” filed Jun. 7, 2024, the entirety of which is incorporated herein by reference.

### TECHNICAL FIELD

This disclosure relates to generative models, and more specifically to techniques for generating multimedia elements as content for electronic messages and social media.

### BACKGROUND

In modern communication, especially in digital formats like texting and social media, multimedia elements like emojis, stickers, and avatars have become an integral tool for expressing emotions, ideas, places, events, and more. These visual symbols help convey messages more effectively and often add a layer of emotional expression that words alone might not fully capture.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system according to aspects of the subject technology.

FIG. 3 illustrates a flowchart of an example process of using a machine learning model to generate multimedia elements according to aspects of the subject technology.

FIG. 4 illustrates a flowchart of an example process of re-training the machine learning model according to aspects of the subject technology.

FIG. 5 illustrates an example electronic system with which aspects of the subject technology may be implemented in accordance with one or more implementations.

FIG. 6 illustrates an example execution of application programming interface (API) instructions according to aspects of the subject technology.

FIG. 7 illustrates an example execution of application programming interface (API) instructions according to aspects of the subject technology.

FIG. 8 illustrates an example computing architecture of a device according to aspects of the subject technology.

FIG. 9 illustrates an example computing architecture of a system according to aspects of the subject technology.

FIG. 10 illustrates an example execution sequence of API instructions according to aspects of the subject technology.

FIG. 11 illustrates an example execution sequence of API instructions according to aspects of the subject technology.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Integrating multimedia elements like images, videos, emojis, and stickers into messages and social media posts is an effective way for enhancing communication in digital environments. Multimedia elements allow users to express emotions and thoughts. For example, emojis and stickers can convey a range of feelings from joy to sarcasm providing clarity which might not be possible with text only messages. Visual content such as images and videos typically attract more attention and engagement than text only content. This is because visual content may be more likely to be shared and commented on which is particularly beneficial in social media settings. Adding multimedia elements can also help users with difficulties in reading or language barriers as multimedia elements may provide a visual guide to help understand the context of the messages.

Practical uses of multimedia elements include social media, where multimedia content can dramatically boost the visibility and appeal of posts for instance a video or photo can draw more viewers, while interactive elements like poll or GIFs can engage them directly with the narrative. Practical uses can also include using multimedia content for personal or professional messaging to convey information quickly and effectively. For example, a quick emoji or a sticker can replace a long sentence and deliver the emotion or reaction immediately. Practical uses can further include use of multimedia content in digital marketing where engaging content can lead to higher conversion rates as videos, interactive ads and timely GIFs can capture interest and help in storytelling more effectively than text.

The use of multimedia elements on user devices presents several limitations impacting user experience. Firstly, the range of multimedia items is narrow and only a few of them are frequently used while many other remain underutilized. Additionally current keyboard settings lack contextual awareness i.e., they do not analyze the content of ongoing conversations or consider previous messages to suggest or create relevant multimedia items. To circumvent these limitations, generative models of the subject system can be used for creating multimedia elements that are more personalized and context aware. Using natural language processing (NLP), generative models can understand the context and sentiment of messages. This allows the models to understand and create multimedia elements that match the tone and content of the messages. These models can also be used to generate new multimedia elements through techniques such as generative adversarial networks (GANS) or variational auto encoders (VAE). Users can input a contextual description in the form of text or images, and the model would generate a multimedia element that fits the description. Over time these models learn individual user preferences and styles adjusting the multimedia elements accordingly.

In certain situations, the multimedia elements generated using generative models can depict a human or a portion of a human. For example, a multimedia element such as an image can depict a person riding a bicycle. Due to the default nature of the generative models, the generated images can depict human skin as having a same skin tone (or color.) However, some users may wish to generate images with a skin tone that mirrors their own which may differ from the default skin tone color.

Providing an option to change the color of the skin tone of a generated multimedia element may require detecting whether the generated multimedia element depicts skin, such as a human or a portion of human with skin. This may present a significant challenge as the generated multimedia elements can vary significantly in design style and color scheme. It also may depend on the generative model and the input provided to the generative model that resulted in the generated multimedia element. This diversity can complicate standard detection methods such as color analysis, as the same skin tone might be represented with different hues, saturations, or brightness levels. Unlike standard multimedia elements which often adhere to specific guidelines set by bodies like Unicode Consortium, generated multimedia elements may not follow any universal standards. This lack of standardization can make it difficult to apply a single method for skin tone detection. Other reasons as to why detecting skin is a challenging task include presence of intricate backgrounds and additional features that interfere with skin tone analysis especially if the skin depicted in the multimedia element is partially covered or if the multimedia element has a distorted depiction of skin.

In the subject system, a user's device may be configured to use generative models for generating custom multimedia elements such as images that include emojis, GIFs, etc. The user of the user device, or an automated agent acting on behalf of the user, can provide a text or an image as input to the generative model. In response, the generative model can process the input to generate an output image. The generative model can also generate an indication of whether the output image depicts any human skin. If it does, the user device can provide an option to the user to change the color of the skin in the image. For example, the user device can either use the generative model to generate multiple images with different skin tones or use image processing methods to generate multiple images with different skin tones. This involves, training the generative model to not only generate custom multimedia elements, but also detect whether the custom multimedia elements depict human skin. Accordingly, the subject system may provide improvements in generating images with different color skin tones.

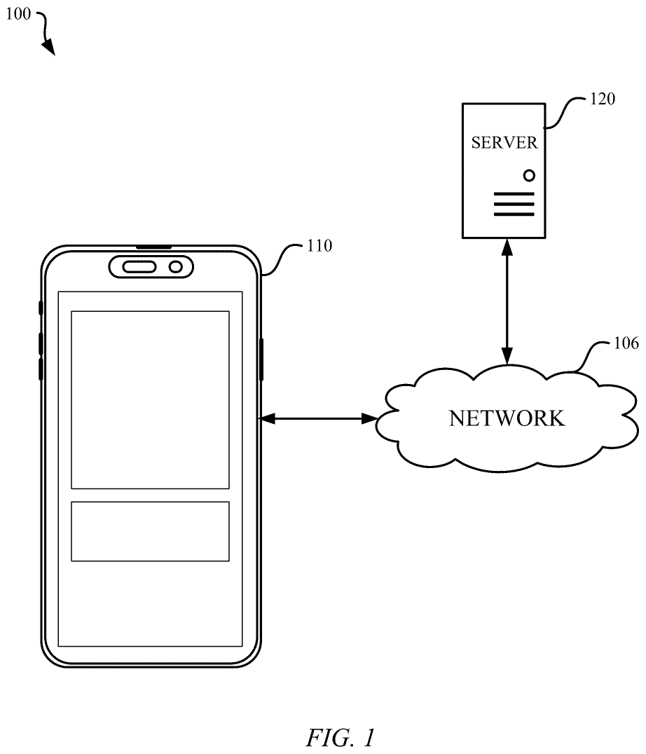

FIG. 1 illustrates an example network environment 100 in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes a user device 110 (also referred herein to as an electronic device), and a server 120. The network 106 may communicatively (directly or indirectly) couple the user device 110 and/or the server 120. In one or more implementations, the network 106 may be an interconnected network of devices that may include, or may be communicatively coupled to, the Internet. For explanatory purposes, the network environment 100 is illustrated in FIG. 1 as including the user device 110, and the server 120; however, the network environment 100 may include any number of electronic devices and any number of servers.

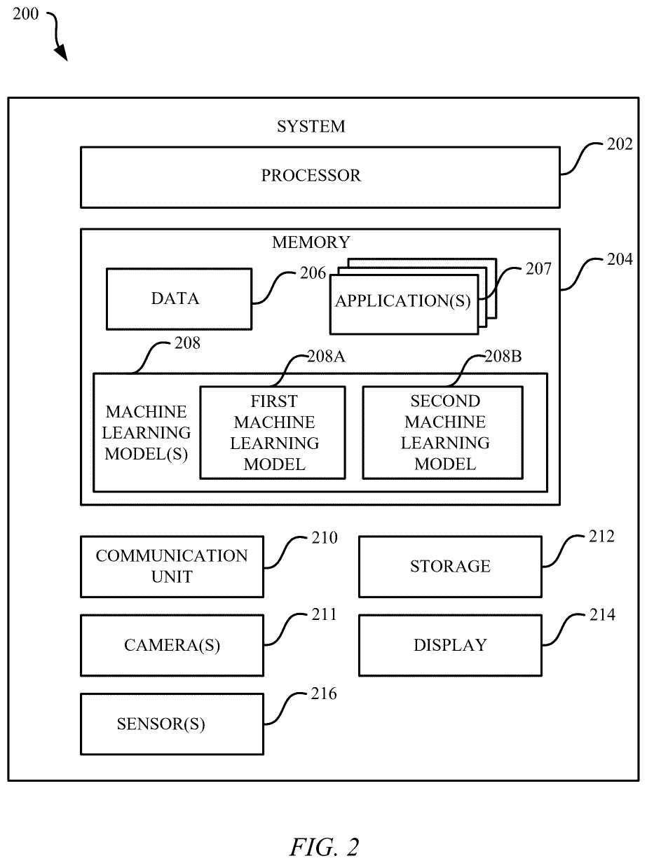

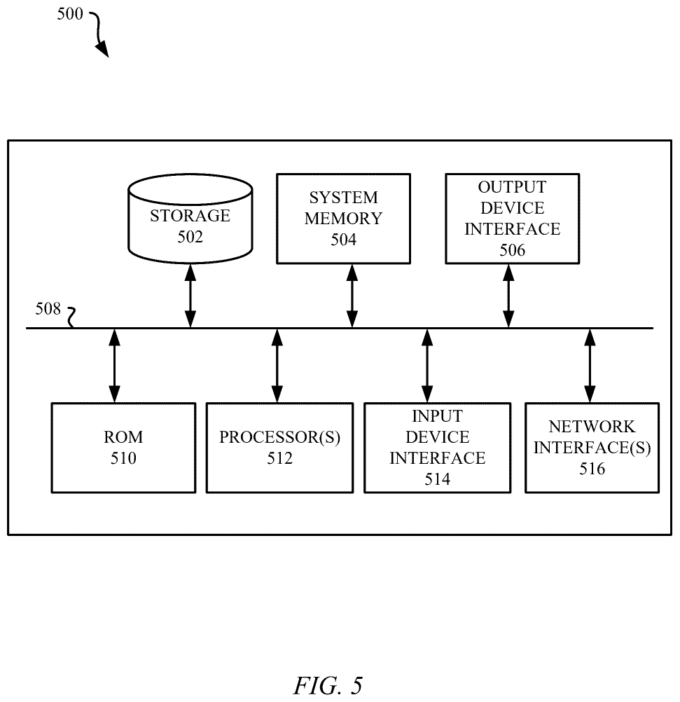

The user device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the user device 110 is depicted as a smartphone. The user device 110 may be, and/or may include all or part of, the systems discussed below with respect to FIG. 2 and/or FIG. 5.

In some implementations, the user device 110 may provide a system for training a machine learning model using training data, where the trained machine learning model is subsequently deployed locally at the user device 110. Further, the user device 110 may provide one or more frameworks for training machine learning models and/or developing applications using the machine learning models. In an example, the user device 110 may be an electronic device (e.g., a smartphone, a tablet device, a laptop computer, a desktop computer, a wearable electronic device, etc.) that can be used to communicate with entities like friends, family, colleagues, customer care support, interactive voice response (IVR) systems, etc.

In some implementations, a server 120 may provide a platform to train one or more machine learning models for deployment to the user device 110. The machine learning models deployed on the user device 110 may then perform one or more machine learning tasks. In some implementations, the server 120 may provide a cloud service that utilizes the trained machine learning model and is continually refined over time. The server 120 may be, and/or may include all or part of, the systems discussed below with respect to FIG. 2 and/or with respect to FIG. 5.

FIG. 2 illustrates an example system 200 in accordance with some implementations of the subject technology. In an example, the system 200 may be implemented in the user device 110 or the server 120. In another example, the system 200 may be implemented either in a single device or in a distributed manner in a plurality of devices, the implementation of which would be apparent to a person skilled in the art.

In an example, the system 200 may include a processor 202, memory 204 (memory device) and a communication unit 210. The memory 204 may store data 206 and one or more machine learning models 208A. In an example, the system 200 may include or may be communicatively coupled with a storage 212. Thus, the storage 212 may be either an internal storage or an external storage. In the example of FIG. 2, the system 200 includes one or more camera(s) 211, a display 214, and one or more sensors(s) 216. Sensor(s) 216 may include location sensors (e.g., satellite positioning system sensors), motion sensors (e.g., inertial sensors), and/or depth sensors (e.g., stereo cameras, LIDAR sensors, radar sensors, time-of-flight sensors, or the like).

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

In an example, the communication unit 210 may include one or more hardware units that support wired or wireless communication between the processor 202 and processors of other computing devices, and/or for communication over a telecommunication network.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory 204 may include one or more applications 207 that are currently being executed on the system 200. The one or more applications 207 can interact with each other or with an operating system of the system 200 using application programming interfaces (API) to send or receive data. The one or more applications 207 can also include respective user interfaces (UI) to facilitate user-interaction, enabling the user to provide inputs and receive output seamlessly. For example, when implemented in the user device 110, the system 200 can execute a messaging application that can provide a UI to receive inputs from the user of the user device 110.

The data 206 may represent, amongst other things, a repository of data processed, received, and generated by one or more processors such as the processor 202. One or more of the aforementioned components of the system 200 may send or receive data, for example, using one or more input/output ports and one or more communication units.

The machine learning (ML) models 208, in an example, may include one or more of machine learning models such as a first ML model 208A that is used to generate multimedia elements for use in messages or social media posts. It also includes a second ML model 208B that may be used to re-train the first ML model 208A for determining whether the generated multimedia elements have certain attributes. In an example, the machine learning model(s) 208 may be trained using training data (e.g., included in the data 206 or other data) and may be implemented by the processor 202 for performing one or more of the operations, as described herein. Even though the following description is with reference to generating an image, the techniques and methods are applicable for any form of multimedia elements such as GIFs, videos, emojis, stickers, etc.

In some implementations, the first ML model 208A is a neural network designed using a transformer architecture and trained to generate images based on an input such as textual descriptions or one or more input images. For example, if the input to the first ML model 208A describes a human on a bicycle, the first ML model 208A can generate an image depicting a human on a bicycle. The first ML model 208A is trained on a large data set consisting of images, textual descriptions, and/or voice recordings. These descriptions may include simple labels, tags or detailed captions explaining the scene or content of the image. The first ML model 208A may use separate embeddings for text and image inputs. The text is typically tokenized and embedded into a vector space while the images can be processed into patches (small grid like portions) and embedded similarly. The transformer structure of the first ML model 208A may include multiple layers of self-attention mechanism that allow the model to weigh different parts of the input text and image patches during the training process.

In some implementations, the first ML model 208A may generate a set of attributes associated with the generated image. For example, when the first ML model 208A generates an image, the first ML model 208A may also generate a plurality of segments of the image where each segment is a discrete group of pixels highlighting a respective region of the image based on the individual pixel properties. For example, if the image depicts a human hand holding a cup, the first ML model 208A will generate two segments. The first segment can highlight the cup and the second segment can highlight the human hand. Each of the plurality of segments may be represented using a respective mask. To represent the masks, the first ML model 208A may generate a three-dimensional matrix representing the height, width, and the number of segments, where the height and the width are the number of pixels of the image along the X-axis and the Y-axis, respectively. To represent each segment, the values of the corresponding two-dimensional matrix representing height and width of the pixels of the image, is set to “1,” if the pixel belongs to the corresponding segment. If the pixel does not belong to the corresponding segment, the value of the pixel is set to “0.”

The set of attributes may further include a type associated to each segment of the plurality of segments. Continuing with the previous example, the first ML model 208A can generate a label indicating a type for each of the two segments. For example, the first ML model 208A can generate a label “Label 1” for the first segment and a label “Label 2” for the second segment. As for another example, the first ML model 208A can generate a label “Cup” for the first segment and a label “Hand” for the second segment.

The training objective of the first ML model 208A includes computing the contrastive loss to ensure that the generated images of the first ML model 208A match the description provided as input. The training also includes providing feedback to the first ML model 208A. The training can further include fine tuning that involves adjusting hyperparameters, extending the training duration or enriching the training data set with more diverse examples.

In some implementations, the first ML model 208A is trained on the server 120 and deployed on the user device 110. The user of the user device 110 can provide an input to the first ML model 208A using a UI such a prompt and a virtual keyboard of the messaging application. For example, the user of the user device 110, while communicating with another user via a messaging application, decides to generate, and send a multimedia element such as an image. To do this, the user may use the UI of the messaging application 207 to provide the input to the first ML model 208A. The input may be a textual description of a scene or an entity such as a human or a portion of a human (e.g., head, face, nose, ear, hand, leg, etc.) The input may also include an image either captured using the camera 211 of the user device 110 or selected from the image gallery of the user device 110. The input may also be a voice recording that can be provided by the user of the user device 110 using the microphone of the user device 110. If the input is a voice recording, the user device 110 can use an automatic speech recognition (ASR) model to convert the voice recording into text and provide the text as input to the first ML model 208A. These ASR models use machine learning algorithms, typically deep learning, to process and transcribe the voice recording and are usually a part of virtual assistants' native to the user device 110. In response to receiving the input, the first ML model 208A may process the input to generate an image. If the user approves the generated image, the user may include the image into the message of the messaging application and transmit the message to a user device of another user.

Depending on the situation, the input may describe an entity such as a human or a portion of a human (e.g., head, face, nose, ear, hand, leg, etc.) For example, the input may describe an appearance of a human, a human emotion, a human action, or a human interaction. The first ML model 208A may process the input to generate an image depicting an entity that matches the description of the input. For example, if the input is a textual description that says, “a man on a cycle”, the generated image can depict a realistic, semi-realistic or an unrealistic image of a human on a cycle such as a sketch of a human on a cycle, or a pictorial representation of a human on a cycle or an emoji depicting a human on a cycle (e.g., the image may be generated in an “emoji” style). In such situations, the user of the user device 110 may want to change the skin tone of the skin of the depicted entity (or the representation of skin such as for an image generated in an “emoji” style) for reasons described above. This would require the user device 110 to automatically determine whether the generated image depicts an entity that shows skin. In response to such a determination, the user device 110 needs to generate one or more alternate images each having a different skin tone. However, since such generated images can be highly diverse, standard detection methods to determine whether the generated image depicts an entity that shows skin may not work.

To circumvent this issue, the first ML model 208A may be retrained on the server 120 prior to deployment on the user device 110 to not only generate images but also identify and flag if the generated images contain a particular attribute. Here, the particular attribute is a portion of the image depicting an entity showing skin. Re-training the first ML model 208A may be performed using a second ML model 208B that is trained to classify images based on whether the images have a particular attribute of an entity showing skin. By utilizing this dual model architecture, the image generation capabilities of model 208A may be optimized to generate images and indicate whether the generated images contain any depiction of skin. The dual model architecture is described in detail below.

In some implementations, the second ML model 208B is a neural network designed using a transformer architecture to process images and the set of attributes associated to the images to generate one or more second images if the input image has a particular attribute of an entity showing skin. In some implementations, the second ML model 208B is a convolutional neural network configured to process an image to determine a set of attributes of the image. The one or more second images are similar to the input image except that they have a different version of the particular attribute. If the image does not have the particular attribute, the second ML model 208B will provide the same input image as output. For example, if an input image depicts an automobile, the second ML model 208B will produce the same image as output, since the image does not depict an entity, let alone an entity showing skin. However, if an image shows a person driving an automobile, the second ML model 208B can generate one or more second images where each of the one or more second images have a different version of the particular attribute. For example, the one or more second images will depict the same scene as the input image, but the portion of the image that shows skin of the person will have a different skin tone.

In some implementations, the second ML model 208B may determine another set of attributes associated with the image that was provided as input. For example, the second ML model 208B may determine a plurality of segments of the image where each segment is a discrete group of pixels highlighting a respective region of the image based on the pixel and the contextual properties. For example, if the image depicts a human hand holding a cup, the second ML model 208B will generate two segments. The first segment may highlight the cup and the second segment may highlight the human hand. Each of the plurality of segments is represented using a respective mask. To represent the masks, the second ML model 208B may generate a three-dimensional matrix as described with reference to the first ML model 208A.

The set of attributes may further include a type associated to each segment of the plurality of segments. Continuing with the above example, the second ML model 208B may generate a label indicating a type for each of the two segments. For example, the second ML model 208B may generate a label “cup” for the first segment and a label “skin” for the second segment as it highlights the human hand. As for another example, the second ML model 208B may generate a label “no skin” for the first segment and a label “skin” for the second segment. As for another example, if the image depicts a human hand wearing gloves and holding a cup, the second ML model 208B may generate a label “cup” for the first segment and a label “hand” for the second segment as it highlights the human hand. Note how the labels indicating the type of segments that are generated using the second ML model 208B are contextually related to the particular attribute of the entity showing skin, when compared to the first ML model 208A.

The set of attributes may further include a skin tone or color associated to each segment. For example, if the cup is red in color, the second ML model 208B may generate a label “Red” indicating the color of the first segment. As for another example, if the color of the hand is yellow, the second ML model 208B may generate a label “Yellow” indicating the color of the second segment. In some embodiments, while generating a label for indicating the skin tone of an entity, the second ML model 208B can limit itself to selecting a label from a pre-defined list of labels. For example, the pre-defined list of labels may include the labels: “Yellow,” “White,” “Brown,” “Black,” etc.

If the set of attributes associated with the image that was provided as input includes the particular attribute i.e., the set of attributes indicate that a segment is of type “Skin,” the second ML model 208B may generate one or more second images with an altered set of attributes. Each of the one or more second images will depict the same entity with the difference being that the portion of the entity that shows skin is now depicted using an altered (or different) skin tone. Continuing with the previous example, the second image will show the human hand holding a cup. In this case, the set of altered attributes would include the same segments i.e., a first segment highlighting the “cup” and a second segment highlighting the “human hand.” The set of altered attributes may further include the same labels for each segment indicating the type of each segment. For example, the second ML model 208B may generate a label “no skin” for the first segment and a label “skin” for the second segment. The set of altered attributes may further include the same label for indicating the skin tone of segments that does not depict skin and an altered label for indicating the altered skin tone of segments that have the particular attribute of depicting skin. For example, if the input image depicts a human hand holding a red cup and the set of attributes include a label “Yellow” indicating the skin tone of the second segment, the generated second image can depict the hand with a white skin tone. In this case, the set of altered attributes can include a label “White” for indicating the altered skin tone of the second segment. As for another example, the second machine ML model 208B may generate another second image depicting the hand with a black skin tone. In this example, the set of altered attributes may include a label “Black” for indicating the altered skin tone of the second segment.

If the second ML model 208B determines that an image does not have the particular attribute, the second ML model 208B will provide the same input image as output. For example, if the second ML model 208B determines that an image does not depict an entity or determines that there is an entity, but it does not show any skin, the second ML model 208B will provide the same input image as output. This configuration of the second ML model 208B allows the server 120 to determine whether an image has a particular attribute of depiction of an entity showing skin. Thus, the server 120 can leverage the second ML model 208B to re-train the first ML model 208A.

In some implementations, the re-training objective of the first ML model 208A is to generate a label indicating the type of segment that is contextually related to the particular attribute of the entity showing skin. In other words, the re-training objective of the first ML model 208A is to leverage the capability of the second ML model 208B in determining whether the image generated by the first ML model 208A contains any depiction of human skin. For example, assume that the first ML model 208A generates an image depicting a human hand holding a cup and also generates a set of attributes associated to the generated image that includes the first segment and the second segment for the cup and the hand, respectively. While generating a label indicating the type of segment, the first ML model 208A should generate the label “Skin” for the second segment contrary to generating the labels “Label2” or “Hand” as described before.

In some implementations, the server 120 may use the second ML model 208B to determine whether any of the generated images by the first ML model 208A has the particular attribute of depiction of skin. For example, the server 120 may use the second ML model 208B to process the images generated by the first ML model 208A to generate a set of attributes. If the second ML model 208B generates a label (e.g., “Skin”) indicating the particular type of a segment, the server 120 can determine that the image has depictions of skin.

If the second ML model 208B does not generate the set of attributes (e.g., determining and/or generating the set of attributes being a passive operation internal to the second ML model 208B), the server 120 may still determine whether an image generated by the first ML model 208A has the particular attribute. In such implementations, the server 120 may use the second ML model 208B to process images generated by the first ML model 208A. If the second ML model 208B generates one or more second images with an altered set of attributes, the server 120 can determine that the image has depictions of skin. For example, if an input image depicts an automobile, the second ML model 208B will produce the same image as output. However, if an image shows a person driving an automobile, the second ML model 208B will generate one or more second images with each of the one or more images have a set of altered attributes indicating different skin tone of the person.

To train the first ML model 208A, the server 120 can create a training dataset that includes multiple training samples where each training sample is a set of inputs that is provided to the first ML model 208A. Each set of inputs can be a description of an image and can include text, images, voice recordings or a combination of text, image, and voice recordings.

In some implementations, the server 120 may re-train the first ML model 208A by making the first ML model 208A compete against the second ML model 208B. In such implementation, the server 120 may iteratively provide inputs from the training dataset to the first ML model 208A to generate a corresponding image along with a set of attributes. The set of attributes can include a plurality of segments, a label indicating the type of each segment, and a label indicating the skin tone of each segment. The server 120 may then use the second ML model 208B to process the images generated by the first ML model 208A along with the set of attributes to determine whether any of the generated images by the first ML model 208A has the particular attribute of an entity showing skin. The determination can be performed using any of the two techniques described above. If the server 120 determines that the generated image has the particular attribute, the server 120 can alter one or more parameters of the first ML model 208A. If the server 120 determines that the generated image does not have the particular attribute, the server 120 can provide the next input from the training dataset to the first ML model 208A.

In some implementations, the server 120 may generate a secondary training dataset for retraining the first ML model 208A. In such implementations, the server 120 may provide the inputs to the first ML model 208A, to generate corresponding images along with sets of attributes. The server 120 can then use the second ML model 208B to process the generated images to determine whether any of the generated images by the first ML model 208A has the particular attribute of an entity showing skin. For example, the server 120 can use the second ML model 208B to process an image from the first ML model 208A to generate a secondary image and an altered set of attributes corresponding to the secondary image. Note that the secondary image is generated only when the image from the first ML model 208A has the particular attribute. The server 120 can then create a training sample for the secondary training dataset. The training sample may include the set of input that was provided to the first ML model 208A, the image that was generated by the first ML model 208A, and the altered set of attributes associated to a second image that was generated by the second ML model 208B.

In some implementations, instead of the set of altered attributes, the training sample may include an indication of which segment among the plurality of segments of the generated image has the particular attribute. In other implementations, the training sample may include the second image generated by the second ML model 208B instead of the altered set of attributes. The objective behind such training samples is to provide the first ML model 208A with scenarios where there is a difference between the output generated by the first ML model 208A and the second ML model 208B. The server 120 can execute the process of generating a training sample multiple times thereby generating multiple training samples for the secondary training dataset.

In some implementations, after generating the secondary training dataset, the server 120 may train the first ML model 208A. During training, the server 120 may use the set of inputs to generate an image using the first ML model 208A along with a set of attributes. The server 120 may then compare the set of attributes to the altered set of attributes from the secondary training dataset and compute a loss value based on a loss function (e.g., Binary cross-entropy loss function) and alter the parameters of the first ML model 208A based on the loss value. The server 120 may repeat the process several times until the loss value is below a certain pre-threshold.

In some implementations, after training the first ML model 208A, the server 120 may push the updated first ML model 208A to the user device 110. If the user of the user device 110, while communicating with another user via messages, decides to generate and send an image, the user may provide an input to the first ML model 208A using a UI of the user device 110. The input may be a textual description of a scene or an entity, and/or a spoken input that can be transcribed to text. The input may also include an image either captured using the camera 211 of the user device 110 or selected from the image gallery of the user device 110. The input may also be a voice recording that can be provided by the user of the user device 110 using the microphone of the user device 110. In response to receiving the input, the first ML model 208A can process the input to generate an image and a set of attributes of the image. For example, if the input describes an automobile, the generated image will depict an automobile. As for another example, if the input describes a person driving an automobile, the generated image will depict a person driving an automobile.

As described before, the set of attributes of an image may include a plurality of segments of the image and a label indicating a type of each segment. If a segment has the particular attribute i.e., if the label indicating the type of the segment is “Skin,” the user device 110 may determine that the generated image depicts an entity showing skin. For example, if the image depicts a person driving an automobile, the set of attributes will include a first segment highlighting the driver and a second segment highlighting the automobile. The set of attributes will further include a label “Skin” indicating the type of the first segment and a label “No-Skin” indicating the type of the second segment. Since, the label for the first segment is “Skin,” the user device 110 may determine that the image has the particular attribute of depicting an entity showing skin.

In response to determining that the image has a particular attribute, the user device 110 may process the image to generate one or more alternate images each having a different version of the particular attribute. For example, the user device 110 may use image processing algorithms to alter the image by changing the skin tone of the segment that depicts an entity showing skin. In some implementations, image processing algorithms may alter the skin tone of the segment depicting skin using skin tones from the pre-defined list namely, “Yellow,” “White,” “Brown,” “Black,” etc. This may cause the color of the portions of the image that includes skin to change while maintaining the color of the portions of the image that do not include skin. For example, the user device 110 can generate four alternate images where each of the four alternate images depict the skin using a respective skin tone from the list.

In some embodiments, the user device 110 may use the first ML model 208A to generate the one or more alternate images each having a different version of the particular attribute. For example, if the user device 110 determines that the generated image depicts an entity showing skin, the user device 110 may instruct the first ML model 208A to generate four alternate images where each of the four alternate images depict the skin using a respective skin tone from the pre-defined list. In some embodiments, the first ML model 208A may generate the one or more alternate images without having the user device 110 provide instructions. For example, the first ML model 208A may be configured to determine whether the generated image depicts an entity showing skin, and in response generate the one or more alternate images.

In some implementation, the user device 110 may also use the second ML model 208B to generate the one or more alternate images each having a different version of the particular attribute. For example, if the user device 110 determines that the generated image depicts an entity showing skin, the user device 110 may generate a request for alternate images and transmit the request to the server 120. The server 120 after receiving the request, may use the second ML model 208B to generate one or more second images. After generating the one or more second images, the server 120 may transmit the images to the user device 110 to be used as one or more alternate images. In some implementations, the second ML model 208B may be executed on the user device 110. For example, the server 120 after training the first ML model 208A, may push both the first ML model 208A and 208B into the user device 110. In such implementations, the user device 110 may directly use the second ML model 208B for generating one or more second images.

In some embodiments, the user device 110 after generating the one or more alternate images, can display the alternate images with different skin tones to the user of the user device 110. For example, user device 110 may use the UI to display the one or more alternate images. In response, the user can select one of the alternate images to select an image that depicts an entity with a particular skin tone. In response to the user selection, the user device 110 may include the selected image in the message currently being drafted by the user for transmission.

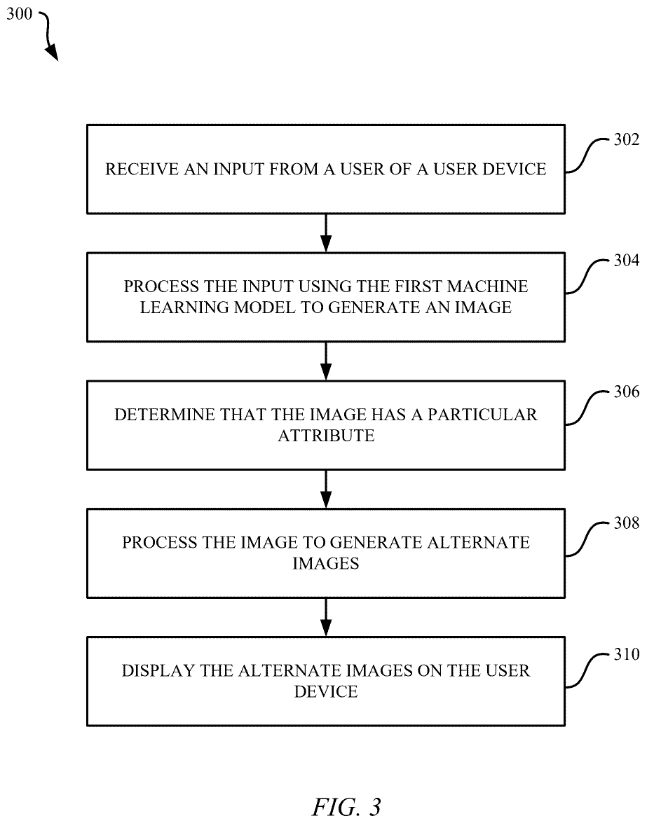

FIG. 3 is a flowchart illustrating an example process 300 of using a first ML model 208 to generate multimedia elements according to aspects of the subject technology. For explanatory purposes, the process 300 is primarily described herein with reference to the user device 110 of FIG. 1. However, the process 300 is not limited to the user device 110 of FIG. 1, and one or more blocks (or operations) of the process 300 may be performed by one or more other suitable devices. Further for explanatory purposes, the blocks of the process 300 are described herein as occurring in serial, or linearly. However, multiple blocks of the process 300 may occur in parallel. In addition, the blocks of the process 300 need not be performed in the order shown and/or one or more blocks of the process 300 need not be performed and/or can be replaced by other operations.

At block 302, the user device 110 receives an input from the user. For example, if the user of the user device 110 decides to generate and send a multimedia element such as an image, the user can provide an input to the first ML model 208A using a UI of the user device 110. The input may be a textual description of a scene or an entity. The input may also include an image either captured using the camera 211 of the user device 110 or selected from the image gallery of the user device 110. The input may also be a voice recording that can be provided by the user of the user device 110 using the microphone of the user device 110.

At block 304, the user device 110 processes the input using the first ML model 208A to generate an image. The first ML model 208A is a neural network designed using a transformer architecture and trained to generate images based on an input such as textual descriptions or one or more input images. The first ML model 208A may also generate a set of attributes associated with the generated image that includes a plurality of segments of the image, a label indicating a type associated to each segment and a label indicating a skin tone associated to each segment.

At block 306, the user device 110 determines that the image has a particular attribute. To determine the particular attribute, the user device 110 may examine the set of attributes generated by the first ML model 208A. For example, the user device 110 may examine the label indicating the type associated with each segment of the plurality of segments. The user device 110 may determine if any segment has a label “Skin.” If the label of a segment is “Skin,” the user device 110 can determine that the generated image depicts an entity showing skin.

At block 308, the user device 110 processes the image to generate one or more alternate images. For example, in response to determining that the image has the particular attribute, the user device 110 may process the image to generate one or more alternate images each having a different version of the particular attribute. For example, the user device 110 may use image processing algorithms, the second ML model 208B, other deep learning or image processing models to alter the image by changing the skin tone of the segment that depicts an entity showing skin. For example, image processing algorithms can alter the skin tone of the segment depicting skin using skin tones from the pre-defined list namely, “Yellow,” “White,” “Brown,” “Black,” etc. In this case, the user device 110 generates four alternate images where each of the four alternate images depict the skin using a respective skin tone from the list.

At block 310, the user device 110 displays the one or more alternate images on the user device 110. For example, user device 110 may use the UI to display the one or more alternate images. In response, the user may select one of the alternate images to select an image that depicts an entity with a particular skin tone. In response to the user selection, the user device 110 may include the selected image in the message currently being drafted by the user for transmission.

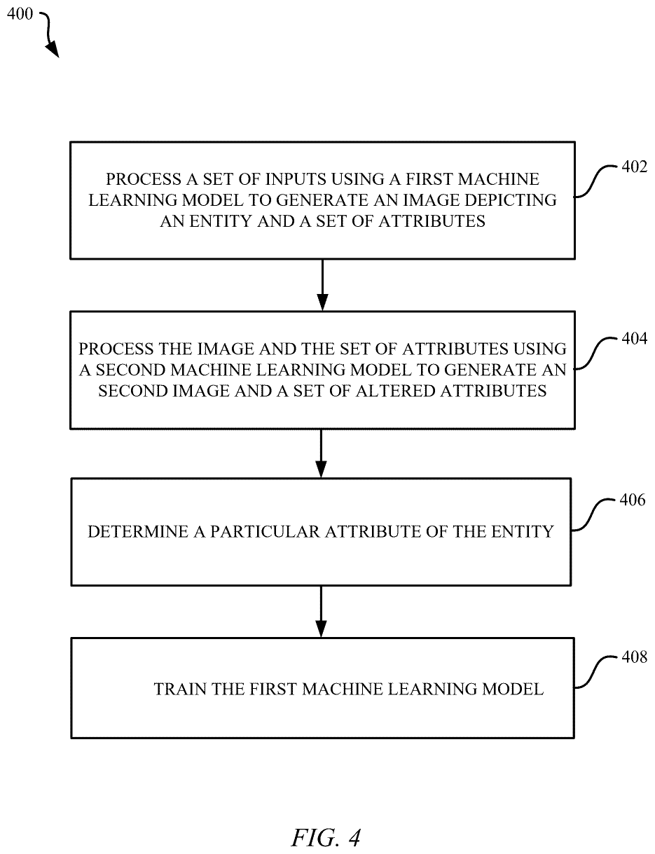

FIG. 4 is a flowchart illustrating an example process 400 of re-training the first ML model 208A according to aspects of the subject technology. For explanatory purposes, the process 400 is primarily described herein with reference to the user device 110 and the server 120 of FIG. 1. However, the process 400 is not limited to the user device 110 and the server 120 of FIG. 1, and one or more blocks (or operations) of the process 400 may be performed by one or more other suitable devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, the server 120 processes a set of inputs using a first ML model 208A to generate an image depicting an entity and a set of attributes. To train the first ML model 208A, the server 120 can create a training dataset that includes multiple training samples where each training sample is a set of inputs that is provided to the first ML model 208A. Each set of inputs can be a description of an image and can include text, images, voice recordings or a combination of text, image, and voice recordings. After generating the training dataset, the server 120 can re-train the first ML model 208A by leveraging the ML model 208B. The server 120 can iteratively provide inputs from the training dataset to the first ML model 208A to generate a corresponding image along with a set of attributes. The set of attributes can include a plurality of segments and a label for each segment indicating the type of segment.

At block 404, the server 120 processes the image and the set of attributes using a second ML model 208B to generate a second image and a set of altered attributes. For example, the server 120 can process the images and the set of attributes generated by the first ML model 208A using the second ML model 208B. If the image that was provided as input have the particular attribute i.e., depiction of an entity showing skin, the second ML model 208B can generate one or more second images with a set of altered attributes. If the image that was provided as input does not have the particular attribute, the second ML model 208B can the same image as output.

At block 406, the server 120 determines a particular attribute of the entity. For example, the server 120 can compare the set of attributes generated by the first ML model 208A to the set of attributes generated by the second ML model 208B. As described with reference to Block 404, the set of attributes generated by the second ML model 208B can either include the set of altered attributes associated to the second image or it can include the set of attributes similar to the image that was provided as input to the second ML model 208B. If the server 120 determines that the attributes include a label “Skin,” the server 120 can determine the particular attribute of the entity and which segments of the image depicts an entity showing skin.

At block 408, the server 120 re-trains the first ML model 208A. In response to determining the particular attribute of the entity and which segments of the image depicts an entity showing skin, the server 120 can create the secondary training dataset that includes multiple training samples. Each training sample may include the set of input that was provided to the first ML model 208A, the image that was generated by the first ML model 208A, and the altered set of attributes associated to a second image that was generated by the second ML model 208B. After generating the secondary training dataset, the server 120 may train the first ML model 208A. During training, the server 120 can use the set of inputs to generate an image using the first ML model 208A along with a set of attributes. The server 120 may then compare the set of attributes to the altered set of attributes from the secondary training dataset and compute a loss value based on a loss function (e.g., Binary cross-entropy loss function) and alter the parameters of the first ML model 208A based on the loss value. The server 120 can repeat the process several times until the loss value is below a certain pre-threshold.

As described above, one aspect of the present technology is the gathering and use of data available from specific and legitimate sources for generating multimedia elements using generative models and detecting one or more attributes related to the multimedia elements. The present disclosure contemplates that in some instances, this gathered data may include personal information data that uniquely identifies or can be used to identify a specific person. Such personal information data can include audio data, voice samples, voice profiles, demographic data, location-based data, online identifiers, telephone numbers, email addresses, home addresses, biometric data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for generating multimedia elements using generative models and detecting one or more attributes related to the multimedia elements.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the example of generating multimedia elements using generative models and detecting one or more attributes related to the multimedia elements, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 5 illustrates an electronic system 500 with which one or more implementations of the subject technology may be implemented. The electronic system 500 can be, and/or can be a part of, server 120 and/or user device 110 shown in FIG. 1. The electronic system 500 may include various types of computer readable media and interfaces for various other types of computer readable media. The electronic system 500 includes a bus 508, one or more processing unit(s) 512, a system memory 504 (and/or buffer), a ROM 510, a permanent storage device 502, an input device interface 514, an output device interface 06, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random-access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks and/or to one or more network nodes, such as the user device 110 or the server 120 shown in FIG. 1, through the one or more network interface(s) 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

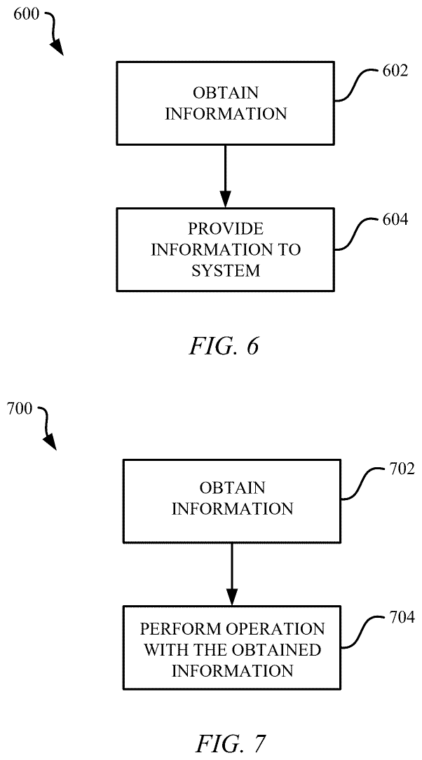

Implementations within the scope of the present disclosure include a computer-readable storage medium that encodes instructions organized as an application (e.g., application 207) that, when executed by one or more processing units, control an electronic device (e.g., user device 110) to perform the method of FIG. 6, the method of FIG. 7, and/or one or more other processes and/or methods described herein.

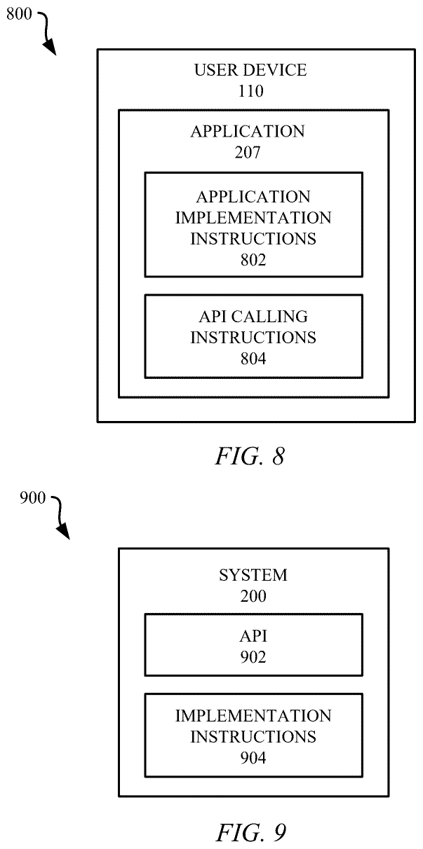

It should be recognized that application 207 (shown in FIG. 8) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 207 is an application that is pre-installed on user device 110 at purchase (e.g., a first party application). In other embodiments, application 207 is an application that is provided to user device 110 via an operating system update file (e.g., a first party application or a second party application). In other embodiments, application 207 is an application that is provided via an application store. In some embodiments, the application store can be an application store that is pre-installed on user device 110 at purchase (e.g., a first party application store). In other embodiments, the application store is a third-party application store (e.g., an application store that is provided by another application store, downloaded via a network, and/or read from a storage device).

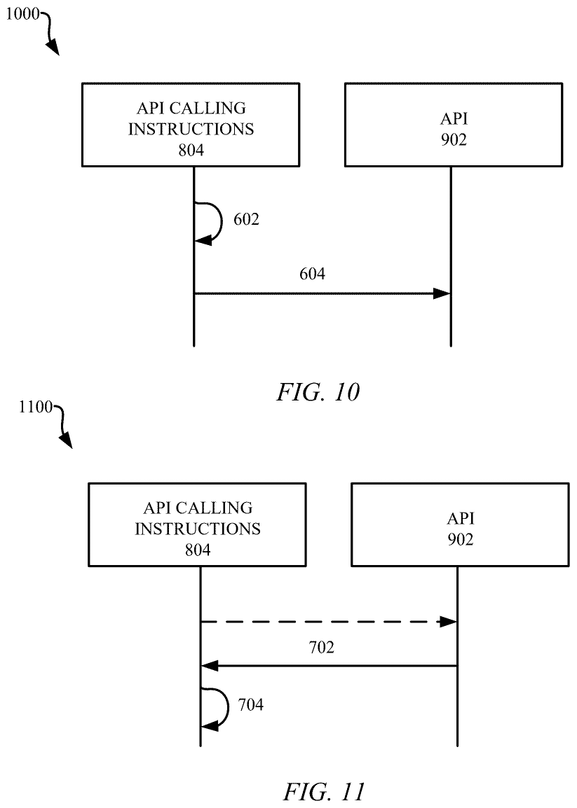

Referring to FIG. 6 and FIG. 10, application 207 obtains information (e.g., at block 602). In some embodiments, at block 602, information is obtained from at least one hardware component of the user device 110. In some embodiments, at block 602, information is obtained from at least one software module (e.g., set of instructions) of the user device 110. In some embodiments, at block 602, information is obtained from at least one hardware component external to the user device 110 (e.g., a peripheral device, an accessory device, a server, etc.). In some embodiments, the information obtained at block 602 includes positional information, time information, notification information, user information, environment information, electronic device state information, weather information, media information, historical information, event information, hardware information, and/or motion information. In some embodiments, in response to and/or after obtaining the information at block 602, application 207 provides the information to a system (e.g., at block 604).

In some embodiments, the system (e.g., block 602 shown in FIG. 6) is an operating system hosted on the user device 110. In some embodiments, the system (e.g., block 602 shown in FIG. 9) is an external device (e.g., a server, a peripheral device, an accessory, a personal computing device, etc.) that includes an operating system.

Referring to FIG. 7 and FIG. 11, application 207 obtains information (e.g., block 702). In some embodiments, the information obtained at block 702 includes positional information, time information, notification information, user information, environment information electronic device state information, weather information, media information, historical information, event information, hardware information and/or motion information. In response to and/or after obtaining the information at block 702, application 207 performs an operation with the information (e.g., block 704). In some embodiments, the operation performed at block 704 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 200 based on the information.

In some embodiments, one or more steps of the method of FIG. 6 and/or the method of FIG. 7 is performed in response to a trigger. In some embodiments, the trigger includes detection of an event, a notification received from system 200, a user input, and/or a response to a call to an API provided by system 200.

In some embodiments, the instructions of application 207, when executed, control user device 110 to perform the method of FIG. 6 and/or the method of FIG. 7 by calling an application programming interface (API) (e.g., API 902) provided by system 200. In some embodiments, application 207 performs at least a portion of the method of FIG. 6 and/or the method of FIG. 7 without calling API 902.

In some embodiments, one or more steps of the method of FIG. 6 and/or the method of FIG. 7 includes calling an API (e.g., API 902) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 8, user device 110 is illustrated. In some embodiments, user device 110 is a personal computing device, a smart phone, a smart watch, a fitness tracker, a head mounted display (HMD) device, a media device, a communal device, a speaker, a television, and/or a tablet. User device 110 includes application 207 and an operating system (not shown) (e.g., system 200 shown in FIG. 9). Application 207 includes application implementation instructions 802 and API calling instructions 804. System 200 includes API 902 and implementation instructions 904. It should be recognized that user device 110, application 207, and/or system 200 can include more, fewer, and/or different components than illustrated in FIGS. 8 and 9.

In some embodiments, application implementation instructions 802 is a software module that includes a set of one or more computer-executable instructions. In some embodiments, the set of one or more instructions of instructions 802 correspond to one or more operations performed by application 207. For example, when application 207 is a messaging application, application implementation instructions 802 can include operations to receive and send messages. In some embodiments, application implementation instructions 802 communicates with API calling instructions to communicate with system 200 via API 902 (shown in FIG. 9).

In some embodiments, API-calling instructions 804 is a software module that includes a set of one or more computer-executable instructions.

In some embodiments, implementation instructions 904 is a software module that includes a set of one or more computer-executable instructions.

In some embodiments, API 902 is a software module that includes a set of one or more computer-executable instructions. In some embodiments, API 902 provides an interface that allows a different set of instructions (e.g., API calling instructions 804) to access and/or use one or more functions, methods, procedures, data structures, classes, and/or other services provided by implementation instructions 904 of system 200. For example, API-calling instructions 804 can access a feature of implementation instructions 904 through one or more API calls or invocations (e.g., embodied by a function or a method call) exposed by API 902 and can pass data and/or control information using one or more parameters via the API calls or invocations. In some embodiments, API 902 allows application 207 to use a service provided by a Software Development Kit (SDK) library. In other embodiments, application 207 incorporates a call to a function or method provided by the SDK library and provided by API 902 or uses data types or objects defined in the SDK library and provided by API 902. In some embodiments, API-calling instructions 804 makes an API call via API 902 to access and use a feature of implementation instructions 904 that is specified by API 902. In such embodiments, implementation instructions 904 can return a value via API 902 to API-calling instructions 804 in response to the API call. The value can report to application 207 the capabilities or state of a hardware component of user device 110, including those related to aspects such as input capabilities and state, output capabilities and state, processing capability, power state, storage capacity and state, and/or communications capability. In some embodiments, API 902 is implemented in part by firmware, microcode, or other low level logic that executes in part on the hardware component.

In some embodiments, API 902 allows a developer of API-calling instructions 804 (which can be a third-party developer) to leverage a feature provided by implementation instructions 904. In such embodiments, there can be one or more set of API-calling instructions (e.g., including API-calling instructions 804) that communicate with implementation instructions 904. In some embodiments, API 902 allows multiple sets of API-calling instructions written in different programming languages to communicate with implementation instructions 904 (e.g., API 902 can include features for translating calls and returns between implementation instructions 904 and API-calling instructions 804) while API 902 is implemented in terms of a specific programming language. In some embodiments, API-calling instructions 804 calls APIs from different providers such as a set of APIs from an OS provider, another set of APIs from a plug-in provider, and/or another set of APIs from another provider (e.g., the provider of a software library) or creator of the another set of APIs.

Examples of API 902 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of user device 110. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 904 is a system (e.g., operating system, server system) software module (e.g., a collection of computer-readable instructions) that is constructed to perform an operation in response to receiving an API call via API 902. In some embodiments, implementation instructions 904 is constructed to provide an API response (via API 902) as a result of processing an API call. By way of example, implementation instructions 904 and API-calling instructions 804 can each be any one of an operating system, a library, a device driver, an API, an application program, or other module. It should be understood that implementation instructions 904 and API-calling instructions 804 can be the same or different type of software module from each other. In some embodiments, implementation instructions 904 is embodied at least in part in firmware, microcode, or other hardware logic.

In some embodiments, implementation instructions 904 returns a value through API 902 in response to an API call from API-calling instructions 804. While API 902 defines the syntax and result of an API call (e.g., how to invoke the API call and what the API call does), API 902 might not reveal how implementation instructions 904 accomplishes the function specified by the API call. Various API calls are transferred via the one or more application programming interfaces between API-calling instructions 804 and implementation instructions 904. Transferring the API calls can include issuing, initiating, invoking, calling, receiving, returning, and/or responding to the function calls or messages. In other words, transferring can describe actions by either of API-calling instructions 804 or implementation instructions 904. In some embodiments, a function call or other invocation of API 902 sends and/or receives one or more parameters through a parameter list or other structure.

In some embodiments, implementation instructions 904 provides more than one API, each providing a different view of or with different aspects of functionality implemented by implementation instructions 904. For example, one API of implementation instructions 904 can provide a first set of functions and can be exposed to third party developers, and another API of implementation instructions 904 can be hidden (e.g., not exposed) and provide a subset of the first set of functions and also provide another set of functions, such as testing or debugging functions which are not in the first set of functions. In some embodiments, implementation instructions 904 calls one or more other components via an underlying API and thus be both a set of API calling instructions and a set of implementation instructions. It should be recognized that implementation instructions 904 can include additional functions, methods, classes, data structures, and/or other features that are not specified through API 902 and are not available to API calling instructions 804. It should also be recognized that API calling instructions 804 can be on the same system as implementation instructions 904 or can be located remotely and access implementation instructions 904 using API 902 over a network. In some embodiments, implementation instructions 904, API 902, and/or API-calling instructions 804 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 300 (FIG. 3) and process 400 (FIG. 4) is performed at the system 200 implemented in the user device 110 or the server 120 (as described herein) via a system process (e.g., an operating system process, a system process) that is different from one or more applications executing and/or installed on the system 200.

In some embodiments, the process 300 (FIG. 3) and the process 400 (FIG. 4) is performed at the system 200 (as described herein) by an application that is different from a system process. In some embodiments, the instructions of the application, when executed, control the system 200 to perform the process 300 (FIG. 3) and the process 400 (FIG. 4) by calling an application programming interface (API) provided by the system process. In some embodiments, the application performs at least a portion of the process 300 (FIG. 3) and the process 400 (FIG. 4) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the system 200 at purchase (e.g., a first party application). In other embodiments, the application is an application that is provided to the system 200 via an operating system update file (e.g., a first party application). In other embodiments, the application is an application that is provided via an application store. In some implementations, the application store is pre-installed on the system 200 at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the system 200 to perform the process 300 (FIG. 3) and the process 400 (FIG. 4) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

As described above, in some embodiments, the application controls the system 200 to perform the process 300 (FIG. 3) and the process 400 (FIG. 4) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., user device 110) that runs the application. In some embodiments, the set of implementation instructions is included in an electronic device that is separate from the device that runs the application.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

What is claimed is:

1. A computer-implemented method, comprising:
receiving an input via a device, wherein the input comprises a description of an entity;
processing the input using a first machine learning (ML) model to generate an image depicting the entity and a set of attributes of the image, wherein the first ML model having been trained to generate images based on inputs describing entities;
determining that the image has a particular attribute from among the set of attributes; and
in response to determining that the image has the particular attribute:
processing the image to generate one or more alternate images each having a different version of the particular attribute; and
providing the one or more alternate images for display on the device.

2. The computer-implemented method of claim 1, wherein set of attributes of the image comprises a plurality of segments of the image, a type associated to each segment of the plurality of segments and a color associated to each segment of the plurality of segments.

3. The computer-implemented method of claim 2, wherein each respective segment in the plurality of segments is depicted using a respective mask for the respective segment.

4. The computer-implemented method of claim 2, wherein the particular attribute comprises a segment among the plurality of segments of the image of a particular type.

5. The computer-implemented method of claim 4, wherein the particular type comprises a skin of the entity.

6. The computer-implemented method of claim 1, wherein the first ML model is a generative model.

7. The computer-implemented method of claim 1, wherein the input comprises at least one of a textual description of the entity, a third image depicting an entity or a voice recording describing the entity.

8. The computer-implemented method of claim 1, wherein processing the image comprises processing the image using the first ML model to generate the one or more alternate images.

9. The computer-implemented method of claim 1, wherein processing the image comprises processing the image using one or more image processing techniques to generate the one or more alternate images.

10. The computer-implemented method of claim 1, wherein processing the image comprises processing the image using a second ML model to generate the one or more alternate images.

11. The computer-implemented method of claim 10, wherein the second ML model is an image processing model.

12. A computer-implemented method comprising:
processing a set of inputs using a first machine learning (ML) model to generate an image depicting an entity and a set of attributes associated with the image;
processing the image and the set of attributes using a second ML model to generate a second image depicting the entity and a set of altered attributes associated with the image;
determining based on the set of attributes and the set of altered attributes, a particular attribute of the entity; and
in response to determining the particular attribute of the entity, training the first ML model using the set of inputs, the image, and the particular attribute.

13. The computer-implemented method of claim 12, wherein the set of inputs comprise at least one of a contextual description of the entity, an image depicting the entity, a voice recording describing the entity.

14. The computer-implemented method of claim 12, wherein determining the particular attribute comprises determining that the image depicts a portion of entity that shows skin.

15. The computer-implemented method of claim 14, wherein the set of altered attributes comprise a different color for the portion of entity that shows skin.

16. The computer-implemented method of claim 12, wherein the second ML model is an image processing model.

17. The computer-implemented method of claim 16, wherein the image processing model is a transformer-based convolutional neural network model.

18. A system, comprising:
a processor; and
a memory device containing instructions which, when executed by the processor, cause the processor to:
receive an input that comprises a description of an entity;
process the input using a first machine learning (ML) model to generate an image depicting the entity and a set of attributes of the image, wherein the first ML model having been trained to generate images based on inputs describing entities;
determine that the image has a particular attribute from among the set of attributes; and
in response to determining that the image has the particular attribute:
process the image to generate one or more alternate images each having a different version of the particular attribute; and
provide the one or more alternate images for display.

19. A system, comprising:
a processor; and
a memory device containing instructions which, when executed by the processor, cause the processor to:
process a set of inputs using a first machine learning (ML) model to generate an image depicting an entity and a set of attributes associated with the image;
process the image and the set of attributes using a second ML model to generate a second image depicting the entity and a set of altered attributes associated with the image;
determine based on the set of attributes and the set of altered attributes, a particular attribute of the entity; and
in response to determining the particular attribute of the entity, train the first ML model using the set of inputs, the image, and the particular attribute.

20. A computer program product comprising code stored in a tangible computer-readable storage medium, the code comprising:
code for receiving an input that comprises a description of an entity;
code for processing the input using a first machine learning (ML) model to generate an image depicting the entity and a set of attributes of the image, wherein the first ML model having been trained to generate images based on inputs describing entities;
code for determining that the image has a particular attribute from among the set of attributes; and
in response to determining that the image has the particular attribute:
code for processing the image to generate one or more alternate images each having a different version of the particular attribute; and
code for providing the one or more alternate images for display.
